(19) United States
(12) Patent Application Publication
(10) Pub. No.: US 2013/0005524 A1
(43) Pub. Date: Jan. 3, 2013

(54) CONTINUOUSLY VARIABLE TRANSMISSION

(76) Inventor: William C. Waugh, Boise, ID (US)

(21) Appl. No.: 13/175,718

(22) Filed: Jul. 1, 2011

(51) Int. Cl. F16H 47/08

(52) U.S. Cl. 475/48

(57) ABSTRACT

The present invention is directed to a continuously variable transmission that includes an input shaft, an output shaft, multiple planetary gear assemblies and a hydraulic system including a pump, a motor and a valve. Two of the planetary gear assemblies, in conjunction with the hydraulic system, work as a speed variation mechanism and as a braking device. A third planetary gear assembly multiplies torque. A sub-transmission serves as the range device, providing for forward or reverse rotation of a final drive shaft or alternately a neutral position wherein there is no rotation of the final drive shaft. In one embodiment, first, second and third planetary gear assemblies, the output shaft, a one-way clutch, the final drive shaft, the hydraulic pump and the hydraulic motor all have an axis of rotation that lies coaxially with a primary axis of rotation of the input shaft.

### BACKGROUND OF THE INVENTION

1. Field of the Invention

The present invention relates generally to transmissions and more particularly to a continuously variable transmission.

2. Background

A transmission provides both torque multiplication and output speed control of a power source. Vehicle transmissions allow an engine to run while a vehicle is at rest, accelerate the vehicle in a timely manner and provide a suitable output speeds congruent with modern roadways. It has been challenging to provide transmissions that meet these functions while maintaining a relatively constant engine output rpm.

Benefit would be realized by providing a transmission that achieves these functions while the engine remains in an optimally efficient rpm range. Because all engines have a specific peak efficiency range, a device which allows an engine to run within this range for a higher proportional amount of its operating time raising overall efficiency.

Continuously variable transmissions (or CVTs) has been proven to increase fuel mileage and vehicle efficiency, however most “shiftless” transmissions have been problematic, including such as low power handling capability, complexity, and high cost of manufacture.

Specific problems with CVT's as well as other modern transmission designs include slippage when it pertains to a belt or clutch system, blocking ring (synchronizer) wear, and heat damage due to torque converters. If the typical wear items are eliminated, the new design should prove superior as it will not require frequent overhauls, throughout the standard life of a vehicle.

One object of the present invention is to provide a continuously variable transmission wherein belt slippage and clutch system slippage are eliminated. Another object of the present invention is to provide a continuously variable transmission wherein blocking ring (synchronizer) wear, and heat damage due to torque converters are eliminated. An additional object of the present invention is to simplify transmission design eliminating pumps, stators and turbines associated with the torque converters for a common automatic transmission.

### SUMMARY OF THE INVENTION

The present invention is directed to a continuously variable transmission that includes multiple gear sets and a hydraulic system with a control valve for use in a motor vehicle, vessel or for connection to any mechanized device, which serves to vary output speed and torque. Two of the gear sets work as the speed variation device in conjunction with a hydraulic pump as a braking device, while the third gear set multiplies torque. A sub-transmission serves as the range device, providing reverse, neutral and drive.

In a preferred embodiment, a continuously variable transmission includes the following rotational elements, each having a substantially identical primary axis of rotation: an input shaft, three planetary gear assemblies, a hydraulic vane type pump, a hydraulic vane type motor, a one-way clutch and an output shaft. A control valve is operatively connected between the pump and motor to direct flow to the motor or an attached reservoir.

Different from most designs, the gears, which are meshed at all times, contribute to the torque production throughout the entire speed range to overdrive, while the hydraulic system acts as a transfer and braking system only, allowing the gear sets to do the majority of the work.

In one embodiment, a sub-transmission is used to select operation mode. A sliding collar with cogs may alternately engage a final drive shaft directly or a reverse cog plate and idler associated with a reverse gear mechanism. Alternately the selector may be positioned between the two for neutral, without the use of clutches.

Simplicity of design in regards to the components lends to lower manufacturing costs. With use of a vane style pump and motor as well as planetary gear assemblies, the design allows all components to be inline. The advantage is use of a lighter weight transmission case as the components withstand strain within themselves as opposed to the use of countershaft, parallel shaft or beveled gears, which cause deflection of components and undue stress on the entire system.

The hydraulic pump and motor may be of the non-variable displacement type. This provides a less complex hydraulic system and depends on the gears to multiply torque in a smooth, stepless fashion.

### DESCRIPTION OF THE DRAWINGS

FIG. 1 is a representative cutaway view of a continuously variable transmission according to the present invention; and

FIG. 2 is a representative schematic view of a continuously variable transmission according to the present invention.

### DETAILED DESCRIPTION OF THE INVENTION

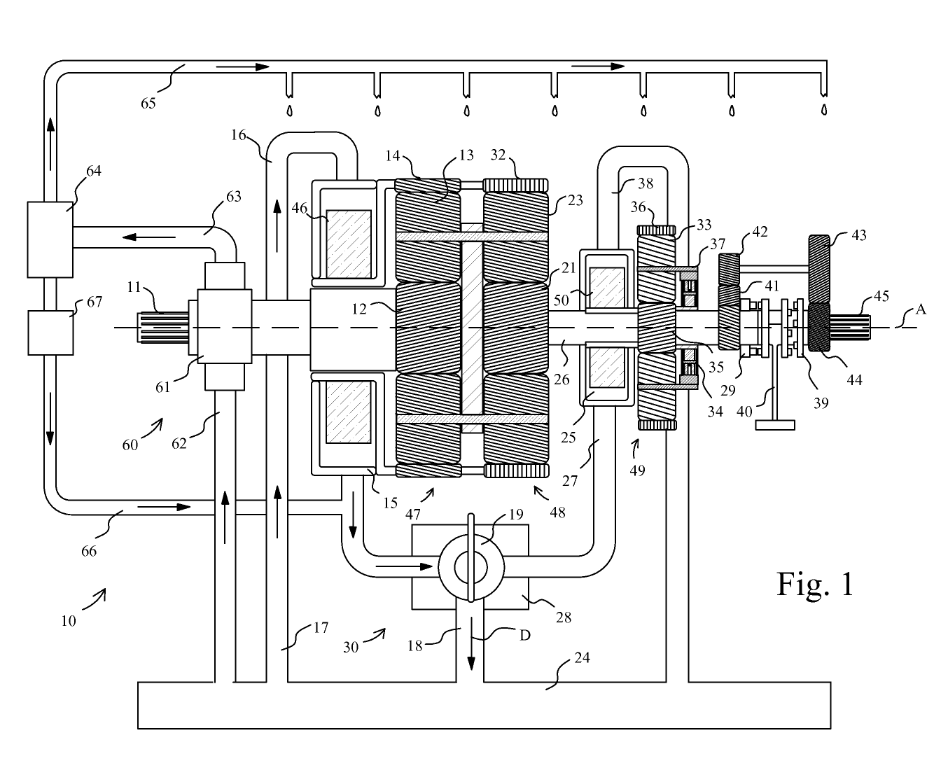

FIGS. 1 through 3 show continuously variable transmission 10 according to a preferred embodiment of the present invention including input shaft 11 and output shaft 26.

Continuously variable transmission 10 also includes three planetary gear assemblies, first planetary gear assembly 47, second planetary gear assembly 48 and third planetary gear assembly 49. Continuously variable transmission 10 also includes primary hydraulic system 30. First planetary gear assembly 47 and second planetary gear assembly 48 operating in conjunction with primary hydraulic system 30, function in combination as a speed variation mechanism and as a braking device. Third planetary gear assembly 49 multiplies torque applied to output shaft 26.

FIGS. 1 through 3 show input shaft 11, first planetary gear assembly 47, second planetary gear assembly 48 and third planetary gear assembly 49, output shaft 26, one-way clutch, final drive shaft 45 as well as hydraulic pump 15 and hydraulic motor 25 all having an axis of rotation that lies coaxially with primary axis of rotation A.

Input shaft 11 is shown including primary axis of rotation A. First sun gear 12 is attached to input shaft 11 for coaxial rotation with input shaft 11. First planet gear set 13 mechanically engage first sun gear 12, imparting a rotational force against first ring gear 14, which is fixed to hydraulic pump 15, of a preferably positive displacement vane type. Planet gear carrier 20 is attached to and rotatable with the first planet gear set 13. Second planet gear set 23 is attached to and rotatable with planet gear carrier 20 such that rotation of the second planet gear set 23 corresponds to rotation of first planet gear set 13. Second sun gear 21 mechanically engages and is rotatable with second planet gear set 23. Second ring gear 32 mechanically engages second planet gear set 23 and is fixed against rotation. As such, all torque transmitted by second planet gear set 23 from first planet gear set 13 is ultimately transmitted to output shaft 26 attached to second sun gear 21.

Primary hydraulic system 30 includes hydraulic pump 15 having pump vane 46 attached to first ring gear 14, such that rotation pump vane 46 corresponds to rotation of first ring gear 14. Primary hydraulic system 30 also includes hydraulic motor 25 including motor vane 50 is hydraulically connected to and drivable by hydraulic pump 15. Hydraulic pump 15 and hydraulic motor 25 are both preferably of a positive displacement vane type. Third sun gear 35 is attached to hydraulic motor 25 such that rotation of third sun gear 35 corresponds to rotation of hydraulic motor 25. Third planet gear set 33 mechanically engages third sun gear 35, such that rotation of the third planet gear set 33 corresponds to rotation of third sun gear 35 on operation of hydraulic motor 25. Third ring gear 36 mechanically engages third planet gear set 33. Third ring gear 36 is fixed against rotation. One-way clutch 34 is operatively disposed between and connected to clutch carrier 37 and output shaft 26. Because third ring gear 36 is fixed against rotation all torque transmitted by hydraulic motor 25 to third sun gear 35 and consequently third planet gear set 33 is ultimately transmitted through one-way clutch 34 to output shaft 26.

Hydraulic system 30 also includes valve 19 hydraulically connected between hydraulic pump 15 and hydraulic motor 25. Valve 19 is configured to selectively regulate a fluid flow from hydraulic pump 15 to hydraulic motor 25, such that as fluid flow increases through hydraulic motor 25 a corresponding rotational force is applied to output shaft 26. Valve 19 is also configured to selectively diminish and cease the fluid flow from hydraulic pump 15 to hydraulic motor 25 in a manner that a progressively increasing hydrostatic lock condition develops between valve 19 and hydraulic pump 15 creating a progressively increasing resistance to rotation of first ring gear 14, causing increased rotational movement of first planet gear set 13 and thereby rotational movement of planet gear carrier 20 causing rotation of output shaft 26.

Valve 19, which may consist of any of a variety of control devices including electric, mechanical, electro-mechanical and electronic, alternately regulates the fluid flow through transfer line 27 to hydraulic motor 25 based on user input or a selected or programmed set of criteria, or through dump line 18 to reservoir. Controller 28 is connected to valve 19, and is configured to analyze data representative of performance of a connected engine, (not shown), to control operation of valve 19. In a preferred embodiment, valve 19 is a three-way variable flow valve controlled by an electronic control unit for a vehicle as is well known to those skilled in the art.

FIGS. 1 through 3 also show auxiliary hydraulic system 60 employed in the preferred embodiment for lubrication of continuously variable transmission 10. Lubrication of continuously variable transmission 10 is achieved by pressurizing a flow through shafts and bearings or in the alternative by a gravity or drip system. Auxiliary pump 61 is rotatably mounted to input shaft 11. Flow from auxiliary pump 61 is directed through lubrication pump output port 63 which in turn is hydraulically connected to pressure regulating valve 64 adapted to direct a lubrication flow having a lubrication flow pressure through lubrication output 65 and an auxiliary flow having an auxiliary flow pressure through auxiliary flow output 65. Lubrication flow lubrication is constant as long as input shaft 11 is rotating. Fluid flow through auxiliary flow output 65 provides added pressure to primary hydraulic system 30. Check valve 67 prevents backflow from primary hydraulic system 30 against auxiliary hydraulic system 60. Fluid flow through auxiliary flow output 65 provides auxiliary pressure to primary hydraulic system 30 sufficient to offset bleed down of hydraulic system 30 that may occur during a hydrostatic lock condition as discussed below.

FIG. 1 shows continuously variable transmission 10 in an idle position. Fluid is drawn by operation of hydraulic pump 15, through pick up line 16 from reservoir 24 and transferred through output line 17 to valve 19. In the idle position, valve 19 is set such that all flow is diverted through port 18 to reservoir 24, as indicated by reference D.

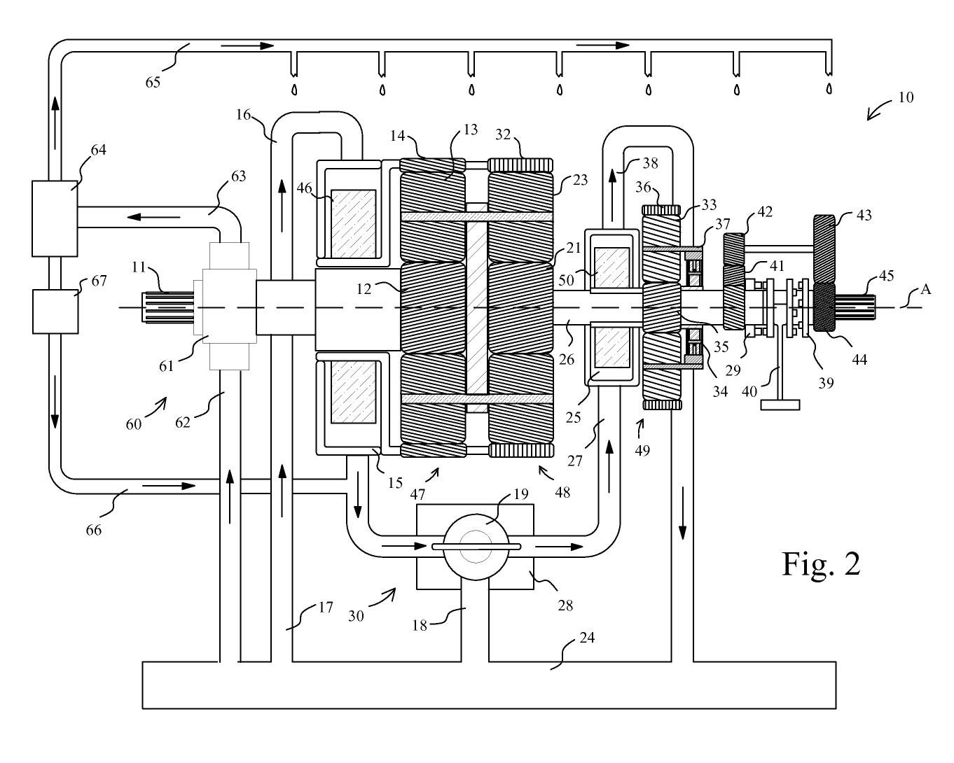

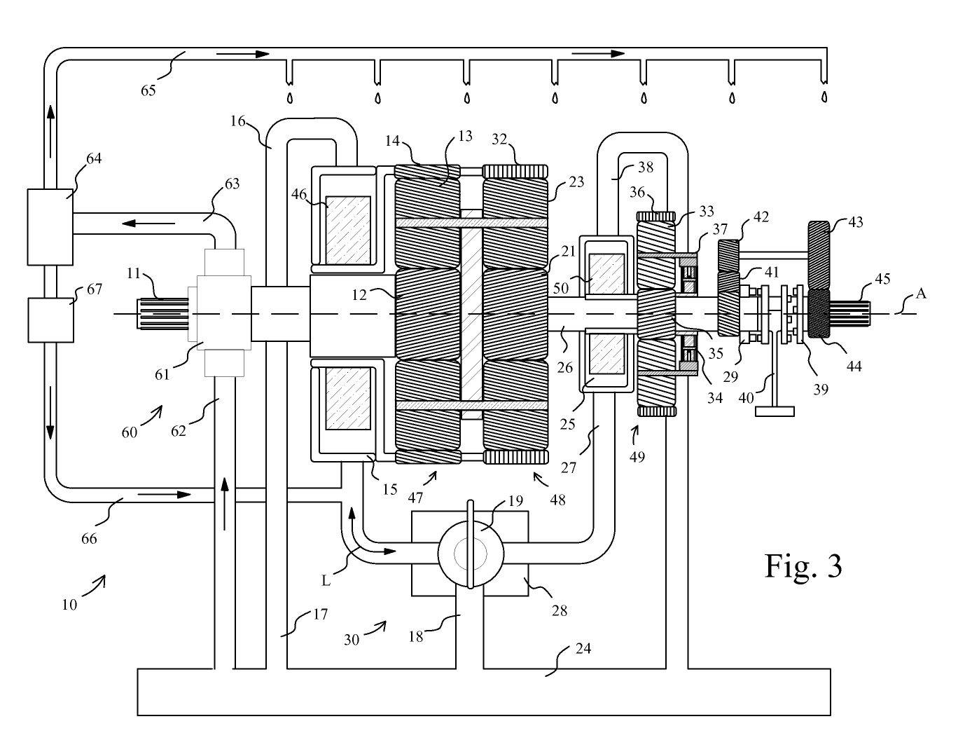

Referring to FIG. 2, fluid is drawn by operation of hydraulic pump 15, through pick up line 16 from reservoir 24 and transferred through output line 17 to valve 19. Valve 19 is set such that all fluid flow FF is directed through transfer line 27 to drive hydraulic motor 25. Beyond hydraulic motor 25, fluid is directed through return line 38 to reservoir 24. Hydraulic motor 25 is connected to third sun gear 35 while third ring gear 36 is fixed against rotation. As third sun gear 35 rotates with operation of hydraulic motor 25, third planet gear set 33 rotates clutch carrier 37 and the attached one-way clutch 34 imparting a rotational force to output shaft 26.

The relatively high torque of the rotational force imparted by hydraulic motor 25 to output shaft 26 is more than adequate to initiate motion of a vehicle, watercraft or other mechanized device connected to continuously variable transmission 10. An initial gear ratio varies on the combination of input shaft 11 to first ring gear 14 and third sun gear 35 to third planet gear set 33. For example, if first ring gear 14 rotates at half speed of input shaft 11, a 2:1 ratio exists combined with a of 3:1 ratio at third planetary gear assembly 49, a 6:1 output gear ratio results, multiplying engine crankshaft torque by six. These ratios may be altered according to manufacturer desire and application. With applicable gear ratios, an overdrive condition may be achieved. Selection of pump size/volume will affect torque as well as relative ratios in the planetary gear assemblies.

Resistance to maintaining a given speed is considerably less that a force required to overcome a state of inertia. As speed of output shat 26 increases, valve 19 is adjusted so as to diminish fluid flow FF to hydraulic motor 25. As fluid flow FF decreases a progressively increasing hydrostatic lock condition L, as shown in FIG. 3, applies a progressively increasing resistance to the rotation of ring gear 14, causing increased rotational movement of first planet gear set 13 and thereby rotational movement of planet gear carrier 20 which is mounted between and rotates with first planet gear set 13 and second planet gear set 22. Second ring gear 23 is fixed against rotation, for instance to the transmission case, (not shown), resulting in rotation of second sun gear 21 and the attached output shaft 26. Eventually, with valve 19 in full lock up mode, no fluid is transferred through primary hydraulic system 30. Ring gear 14, hydraulic pump 15 and therefore hydraulic motor 25 cease rotation. Third planetary gear assembly 49, which includes third sun gear 35, third planet gear set 33 and third ring gear 36, remains idle due to operation and orientation of one way clutch 34.

Continuously variable transmission 10 provides torque multiplication at low output rpm, where needed and a variation in output rpm through a range of zero rpm to an rpm greater than that of an engine, (not shown), connected to input shaft 11. Operation of the continuously variable transmission throughout its range is relatively seamless and step-less, allowing smooth operation.

In the embodiment shown in FIGS. 1 through 3, sub-transmission 55 is connected to output shaft 26. Sub-transmission 55 includes final drive shaft 45 which alternately couplable to output shaft 26 via cog collar 29 or range cog plate 29 and idlers 41-44 by movement of selector 40. In the preferred embodiment, selector 40 may be positioned for forward, reverse or neutral range.

While this invention has been described with reference to the described embodiments, this is not meant to be construed in a limiting sense. Various modifications to the described embodiments, as well as additional embodiments of the invention, will be apparent to persons skilled in the art upon reference to this description. It is therefore contemplated that the appended claims will cover any such modifications or embodiments as fall within the true scope of the invention.

What is claimed is:

1. A continuously variable transmission comprising:
an input shaft having a primary axis of rotation;
a first sun gear attached to the input shaft for coaxial rotation with the input shaft;
a first planet gear set mechanically engaged and rotatable with the first sun gear;
a first ring gear mechanically engaged and rotatable with first planet gear set;
a planet gear carrier attached to and rotatable with the first planet gear set;
a second planet gear set attached to and rotatable with the planet gear carrier such that rotation of the second planet gear set corresponds to rotation of the first planet gear set;
a second sun gear mechanically engaged and rotatable with the second planet gear set;
a second ring gear mechanically engaged with second planet gear set, the second ring gear fixed against rotation;
an output shaft attached to the second sun gear for rotation with the second sun gear;
a primary hydraulic system including a hydraulic pump attached to the first ring gear, the hydraulic pump operable upon rotation of the first ring gear and a hydraulic motor connected to and drivable by the hydraulic pump;
a third sun gear attached to and rotatable upon operation of the hydraulic motor;
a third planet gear set mechanically engaged with the third sun gear, the third planet gear set rotatable with the third sun gear upon operation of the hydraulic motor;
a third ring gear mechanically engaged with third planet gear set, the third ring gear fixed against rotation;
a clutch carrier attached to and rotatable with the third planet gear set;
a one-way clutch operatively disposed between and connected to the clutch carrier and the output shaft; and
a valve hydraulically connected between the hydraulic pump and the hydraulic motor, the valve configured to selectively regulate a fluid flow from the hydraulic pump to the hydraulic motor, such that as the fluid flow is increased through the hydraulic motor an increasing rotational force is applied to the output shaft, and such that as the fluid flow to the hydraulic motor is diminished, a progressively increasing hydrostatic lock condition applies a progressively increasing resistance to rotation of the first ring gear, causing increased rotational movement of first planet gear set and thereby rotational movement of the planet gear carrier causing rotation of the output shaft.

2. The continuously variable transmission of claim 1 further comprising an auxiliary hydraulic system including an auxiliary pump rotatably connected to the input shaft, the auxiliary hydraulic system adapted to provide an auxiliary hydraulic flow to the primary hydraulic system.

3. The continuously variable transmission of claim 1 further comprising a range selector assembly attached between the output shaft and a final drive shaft, the range selector assembly adapted to provide an alternately selectable forward range and an alternately selectable neutral range.

4. The continuously variable transmission of claim 1 further comprising a range selector assembly attached between the output shaft and a final drive shaft, the range selector assembly adapted to provide an alternately selectable forward range, an alternately selectable reverse range and an alternately selectable neutral range.

5. The continuously variable transmission of claim 1 further comprising a controller connected to the valve, the controller configured to analyze data representative of engine performance to control operation of the valve.

6. The continuously variable transmission of claim 1 wherein the hydraulic pump further comprises a positive displacement vane type hydraulic pump, the hydraulic pump including a vane having an axis of rotation that lies coaxially with the primary axis of rotation.

7. The continuously variable transmission of claim 1 wherein the hydraulic motor further comprises a positive displacement vane type hydraulic motor, the hydraulic motor including a vane having an axis of rotation that lies coaxially with the primary axis of rotation.

8. The continuously variable transmission of claim 1 wherein the valve further comprises an electronically controlled three-way variable flow valve.

9. A continuously variable transmission comprising:
an input shaft having a primary axis of rotation;
a first planetary gear assembly connected to the input shaft, the first planetary gear assembly having an axis of rotation that lies coaxially with the primary axis of rotation;
a planet gear carrier attached to and rotatable with the first planetary gear assembly, the planet gear carrier having an axis of rotation that lies coaxially with the primary axis of rotation;
a second planetary gear assembly attached to the planet gear carrier, the second planetary gear assembly having an axis of rotation that lies coaxially with the primary axis of rotation;
an output shaft connected to and rotatable with the second planetary gear assembly, the output shaft having an axis of rotation that lies coaxially with the primary axis of rotation;
a primary hydraulic system including a hydraulic pump attached to the first planetary gear assembly, the hydraulic pump operable upon rotation of the planetary gear assembly, the hydraulic pump including a vane having an axis of rotation that lies coaxially with the primary axis of rotation and a hydraulic motor hydraulically connected to and drivable by the hydraulic pump, the hydraulic motor including a vane having an axis of rotation that lies coaxially with the primary axis of rotation;
a third planetary gear assembly attached to the hydraulic motor, the third planetary gear assembly having an axis of rotation that lies coaxially with the primary axis of rotation;
a clutch carrier attached to and rotatable with the third planetary gear assembly, the clutch carrier having an axis of rotation that lies coaxially with the primary axis of rotation;
a one-way clutch operatively disposed between and connected to the clutch carrier and the output shaft, the one-way clutch having an axis of rotation that lies coaxially with the primary axis of rotation; and
a valve hydraulically connected between the hydraulic pump and the hydraulic motor configured to selectively regulate a fluid flow from the hydraulic pump to the hydraulic motor, such that as the fluid flow is increased through the hydraulic motor an increasing rotational force is applied to the output shaft, and such that as the fluid flow to the hydraulic motor is diminished, a progressively increasing hydrostatic lock condition applies a progressively increasing resistance to rotation of the first ring gear, causing increased rotational movement of first planet gear set and thereby rotational movement of the planet gear carrier causing rotation of the output shaft.

10. The continuously variable transmission of claim 9 further comprising an auxiliary hydraulic system including an auxiliary pump rotatably connected to the input shaft, the auxiliary hydraulic system adapted to provide an auxiliary hydraulic flow to the primary hydraulic system.

11. The continuously variable transmission of claim 9 further comprising a range selector assembly attached between the output shaft and a final drive shaft, the range selector assembly adapted to provide an alternately selectable forward range and an alternately selectable neutral range.

12. The continuously variable transmission of claim 9 further comprising a range selector assembly attached between the output shaft and a final drive shaft, the range selector assembly adapted to provide an alternately selectable forward range, an alternately selectable reverse range and an alternately selectable neutral range.

13. The continuously variable transmission of claim 9 further comprising a controller connected to the valve, the controller configured to analyze data representative of engine performance to control operation of the valve.

14. The continuously variable transmission of claim 9 wherein the valve further comprises an electronically controlled variable flow valve.

15. A continuously variable transmission consisting essentially of:
an input shaft having a primary axis of rotation;
a first planetary gear assembly connected to the input shaft, the first planetary gear assembly having an axis of rotation that lies coaxially with the primary axis of rotation;
a planet gear carrier attached to and rotatable with the first planetary gear assembly, the planet gear carrier having an axis of rotation that lies coaxially with the primary axis of rotation;
a second planetary gear assembly attached to the planet gear carrier, the second planetary gear assembly having an axis of rotation that lies coaxially with the primary axis of rotation;
an output shaft connected to and rotatable with the second planetary gear assembly, the output shaft having an axis of rotation that lies coaxially with the primary axis of rotation;
a primary hydraulic system including a hydraulic pump attached to the first planetary gear assembly, the hydraulic pump operable upon rotation of the planetary gear assembly, the hydraulic pump including a vane having an axis of rotation that lies coaxially with the primary axis of rotation and a hydraulic motor hydraulically connected to and drivable by the hydraulic pump, the hydraulic motor including a vane having an axis of rotation that lies coaxially with the primary axis of rotation;
an auxiliary hydraulic system including an auxiliary pump rotatably connected to the input shaft, the auxiliary hydraulic system adapted to provide an auxiliary hydraulic flow to the primary hydraulic system;
a third planetary gear assembly attached to the hydraulic motor, the third planetary gear assembly having an axis of rotation that lies coaxially with the primary axis of rotation;
a clutch carrier attached to and rotatable with the third planetary gear assembly, the clutch carrier having an axis of rotation that lies coaxially with the primary axis of rotation;
a one-way clutch operatively disposed between and connected to the clutch carrier and the output shaft, the one-way clutch having an axis of rotation that lies coaxially with the primary axis of rotation; and
a variable flow valve hydraulically connected between the hydraulic pump and the hydraulic motor, the variable flow valve configured to selectively regulate a fluid flow from the hydraulic pump to the hydraulic motor, such that as the fluid flow is increased through the hydraulic motor an increasing rotational force is applied to the output shaft; and
the variable flow valve configured such that as the fluid flow to the hydraulic motor is diminished, a progressively increasing hydrostatic lock condition applies a progressively increasing resistance to rotation of the first ring gear, causing increased rotational movement of first planet gear set and thereby rotational movement of the planet gear carrier causing rotation of the output shaft.

16. The continuously variable transmission of claim 15 further comprising an auxiliary hydraulic system including an auxiliary pump rotatably connected to the input shaft, the auxiliary hydraulic system adapted to provide an auxiliary hydraulic flow to the primary hydraulic system.

17. The continuously variable transmission of claim 15 further comprising a range selector assembly attached between the output shaft and a final drive shaft, the range selector assembly adapted to provide an alternately selectable forward range and an alternately selectable neutral range.

18. The continuously variable transmission of claim 15 further comprising a range selector assembly attached between the output shaft and a final drive shaft, the range selector assembly adapted to provide an alternately selectable forward range, an alternately selectable reverse range and an alternately selectable neutral range.

19. The continuously variable transmission of claim 15 further comprising a controller connected to the valve, the controller configured to analyze data representative of engine performance to control operation of the valve.

20. The continuously variable transmission of claim 15 wherein the valve further comprises an electronically controlled variable flow valve.
